(19) United States
(12) Patent Application Publication
(10) Pub. No.: US 2026/0176105 A1
(43) Pub. Date: Jun. 25, 2026

(54) ELEVATOR CAR COMPRISING A BALUSTRADE

(71) Applicant: Otis Elevator Company, Farmington, CT (US)

(72) Inventors: Maria Dolores Garcia-Suelto, Leganés (ES); Marcos Marra, Leganés (ES); Salvador Garcia, Leganés (ES)

(21) Appl. No.: 19/392,879

(22) Filed: Nov. 18, 2025

(30) Foreign Application Priority Data
Dec. 20, 2024 (EP) 24383444.7

(51) Int. Cl. B66B 5/00; B66B 11/02

(52) U.S. Cl. CPC B66B 5/0081; B66B 11/0226

(57) ABSTRACT

An elevator car (6) includes at least one movable balustrade (22) configured to transition between a retracted configuration and an extended configuration in which it projects from a top of the elevator car (6). The at least one movable balustrade (22) includes at least one movable element (22, 32) that is linearly movable between a retracted position and an extended position.

### FOREIGN PRIORITY

This application claims priority to European Patent Application No. 24383444.7, filed Dec. 20, 2024, and all the benefits accruing therefrom under 35 U.S.C. § 119, the contents of which in its entirety are herein incorporated by reference.

### TECHNICAL FIELD OF INVENTION

The invention relates to an elevator car, in particular to an elevator car comprising a balustrade, more particular a movable balustrade, arranged at the top of the elevator car. The invention further relates to an elevator system comprising an elevator car that is equipped with a movable balustrade, and to a method of transitioning a movable balustrade between a retracted configuration and an extended configuration.

### BACKGROUND OF THE INVENTION

An elevator system typically comprises at least one elevator car that is configured for moving along a hoistway between a plurality of landings.

A person, in particular a mechanic, may climb onto the roof of the elevator car, for example for inspection, repair and/and maintenance of the elevator system. Elevator safety codes may require that the elevator car is equipped with a balustrade that extends upwards from the roof of the elevator car in order to prevent persons working on the roof of the elevator car from falling off the elevator car.

A balustrade projecting from the roof of the elevator car may require an upper extension of the hoistway in order to allow the elevator car to reach its uppermost position in the hoistway, in particular a position at the uppermost landing. In case the elevator system does not comprise such an extension, the balustrade could bump against the top of the hoistway before the elevator car has reached the uppermost position.

It would therefore be beneficial to provide an elevator car comprising at least one balustrade that prevents persons working on the roof of the elevator car from accidentally falling off the elevator car, but which does not require providing an upper extension of the hoistway for allowing the elevator car to reach its uppermost position in the hoistway.

### SUMMARY OF THE INVENTION

An elevator car according to an exemplary embodiment of the invention comprises at least one movable balustrade that is capable of transitioning between a retracted configuration and an extended configuration in which it extends from the top of the elevator car. The at least one movable balustrade comprises at least one movable element that is linearly movable between a retracted position corresponding to the retracted configuration of the movable balustrade and an extended position corresponding to the extended configuration of the movable balustrade.

According to an exemplary embodiment of the invention, a method of transitioning the configuration of at least one movable balustrade that is provided at an elevator car between a retracted configuration and an extended configuration includes moving at least one movable element of the at least one movable balustrade linearly from a retracted position into an extended position in which the at least one movable element projects from a top of the elevator car; and/or moving the at least one movable element linearly from the extended position into the retracted position.

Exemplary embodiments of the invention further include an elevator system comprising an elevator car that is equipped with a movable balustrade according to an exemplary embodiment of the invention and that is configured for traveling in a hoistway along a longitudinal direction between a plurality of landings.

In the extended configuration, the movable balustrade reliably prevents persons, in particular mechanics, working on the roof of the elevator car from accidentally falling off the elevator car. In the retracted configuration, the movable balustrade does not obstruct the movement of the elevator car to its uppermost position in the hoistway.

A movable balustrade according to exemplary embodiments of the invention provides a simple and economical solution. It may be implemented using a small amount of additional material resulting in low costs. A movable balustrade according to an exemplary embodiment may be handled easily.

When a movable balustrade according to an exemplary embodiment of the invention is in the retracted configuration, it does not occupy any space on the roof of the elevator car. It further does not obstruct access to the roof and/or to components that are installed on the roof of the elevator car.

In the following, a number of optional features of an elevator system according to exemplary embodiments of the invention are set out. These features may be realized in particular embodiments, alone or in combination with any of the other features, unless explicitly stated otherwise.

When arranged in the extended position, the at least one movable element may project a first distance from the top of the elevator car.

When it is arranged in the retracted position, the at least one movable element may project a second distance from the top of the elevator car, with the second distance being smaller than the first distance.

Optionally, the at least one movable element does not project at all from the top of the elevator car when it is arranged in the retracted position. When arranged in the retracted position, the at least one movable element may in particular be accommodated in a recess or groove provided in the roof of the elevator car.

In consequence, the movable balustrade is capable of reliably preventing a person from accidentally falling off the roof of the elevator car, when it is arranged in the extended configuration. When it is arranged in the retracted configuration, the movable balustrade does not obstruct movement of the elevator car to the top of the hoistway.

The at least one movable balustrade may comprise a telescopic mechanism including a first movable element that is linearly movable with respect to a sidewall and/or with respect to the roof of the elevator car and a second movable element that is linearly movable with respect to the first movable element.

The telescopic mechanism may comprise three or more movable elements that are movable with respect to each other along the longitudinal direction.

Such a telescopic mechanism allows for reducing the height of the movable balustrade in the retracted configuration. A telescopic mechanism further allows for reducing the distance over which the movable elements are moved between their respective retracted positions and their respective extended positions without reducing the safety by decreasing the height of the movable balustrade in the extended configuration.

Each of the first and second movable elements may comprise at least one leg extending along the longitudinal direction. Each of the first and second movable elements may in particular comprise at least two legs extending parallel to each other along the longitudinal direction and at least one connecting element extending between the at least two legs for forming a railing that may prevent a person from accidentally falling off the roof of the elevator car when the movable balustrade is in the extended configuration. The at least one connecting element may in particular extend perpendicularly to the at least two legs.

For forming the telescopic mechanism, at least a lower portion of the at least one leg of the second movable element may be movably arranged in a hollow space that is formed in a corresponding leg of the first movable element in a configuration that allows the second movable element to move linearly along the longitudinal direction with respect to the first movable element.

The elevator car may further comprise at least one guide member that is provided at a sidewall of the elevator car. At least a lower portion of the at least one leg of the first movable element may be movably arranged in a hollow space formed in the at least one guide member in a configuration that allows the first movable element to move linearly along the longitudinal direction with respect to the at least one guide member.

Such a configuration provides a simple and reliable telescopic mechanism that allows for moving the first and second movable elements linearly along the longitudinal direction between the retracted position and the extended position.

A sidewall of the elevator car may comprise at least one structural panel and at least one outer panel, for example a laminated panel, that is attached to an outside of the at least one structural panel. The at least one guide member may be attached to, or formed by, the at least one outer panel.

The at least one outer panel may comprise at least one U-shaped portion, and the at least one guide member may be attached to, or formed by, the at least one U shaped portion of the at least one outer panel.

The elevator car may further comprise at least one locking mechanism that allows for locking the at least one movable element in at least one of the retracted position and the extended position for preventing the at least one movable element from unintentionally moving between the extended position and the retracted position.

The at least one locking mechanism may comprise at least one bolt or screw extending transversely through the at least one movable element for blocking any movement of the at least one movable element along the longitudinal direction.

The at least one locking mechanism may comprise at least one latch that engages with a notch, recess or opening for locking the locking mechanism. The at least one latch may be movable out of engagement with the corresponding notch, recess or opening for unlocking the locking mechanism.

The at least one locking mechanism may in particular comprise a traction member, such as a rope or cable, that allows for selectively disengaging the at least one latch from the notch, recess or opening by pulling the traction member. A locking mechanism comprising such a traction member may be unlocked conveniently from the roof of the elevator car.

The at least one locking mechanism may comprise at least one elastic element that is configured for urging the at least one bolt or latch into a locking position in which it reliably locks the at least one movable element.

### BRIEF DESCRIPTION OF THE DRAWINGS

In the following, exemplary embodiments of the invention are described in more detail with respect to the enclosed figures:

FIG. 1 depicts a schematic view of an elevator system according to an exemplary embodiment of the invention.

FIG. 2A depicts a schematic side view of a sidewall of an elevator car according to an exemplary embodiment of the invention comprising a movable balustrade.

FIG. 2B depicts a schematic sectional view of a locking mechanism that may be employed in an elevator car according to an exemplary embodiment of the invention.

FIG. 3 depicts a schematic sectional view of an elevator car according to an exemplary embodiment of the invention comprising a movable balustrade.

FIG. 4A depicts a perspective view of a portion of an elevator car according to a further embodiment of the invention comprising a movable balustrade in an extended configuration.

FIG. 4B depicts an enlarged view of the movable balustrade depicted in FIG. 4A.

FIG. 5A depicts a perspective view of the portion of an elevator car depicted in FIGS. 4A and 4B with the movable balustrade being in a retracted configuration.

FIG. 5B depicts an enlarged view of the movable balustrade depicted in FIG. 5A.

### DETAILED DESCRIPTION OF THE INVENTION

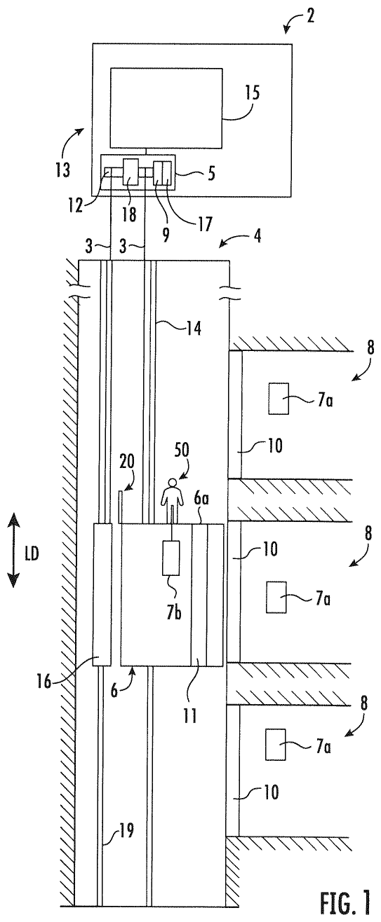

FIG. 1 schematically depicts an elevator system 2 according to an exemplary embodiment of the invention.

The elevator system 2 comprises a hoistway 4 extending along a longitudinal direction LD between a plurality of landings 8 located on different floors. The elevator system 2 includes an elevator car 6 that is arranged in the hoistway 4 for being moved along the longitudinal direction LD between the plurality of landings 8. The elevator car 6 may in particular be movable along at least one elevator car guide rail 14 provided in the hoistway 4 and extending along the longitudinal direction LD.

The longitudinal direction LD may be oriented in a vertical direction, as it is depicted in FIG. 1. In an alternative embodiment, which is not depicted in the figures, the longitudinal direction LD may be inclined with respect to the vertical direction.

Although only a single elevator car guide rail 14 is depicted in FIG. 1, the elevator system 2 may comprise a plurality of elevator car guide rails 14 extending parallel to each other.

Although only a single elevator car 6 is depicted in FIG. 1, exemplary embodiments of the invention may also include elevator systems 2 comprising a plurality of elevator cars 6 moving in one or more hoistways 4.

The elevator car 6 is movably suspended by means of a tension member 3. Although only a single tension member 3 is depicted in FIG. 1, exemplary embodiments of the invention may also include elevator systems 2 comprising a plurality of tension members 3.

The at least one tension member 3, for example a rope or belt, is coupled to an elevator drive system 5. The elevator drive system 5 comprises a motor 9 for rotatably driving a shaft 12, and a drive 17 that harnesses and controls the electrical energy supplied to the motor 9. The elevator drive system 5 is configured for driving the at least one tension member 3, which is coupled to the shaft 12 via traction, in order to move the elevator car 6 in the hoistway 4 along the longitudinal direction LD between the plurality of landings 8.

The elevator drive system 5 is further provided with at least one elevator brake 18 for braking rotation of the shaft 12 in order to allow for stopping movement of the elevator car 6 and holding the elevator car 6 at a desired position in the hoistway 4.

Optionally, the elevator system 2 may comprise a counterweight 16. The counterweight 16 may be attached to the at least one tension member 3 opposite to the elevator car 6 and configured for moving concurrently and in opposite direction with respect to the elevator car 6. The counterweight 16 may move along at least one counterweight guide rail 19 provided in the hoistway 4 and extending along the longitudinal direction LD.

The at least one tension member 3 may be a rope, e.g. a steel cord, or a belt, in particular a coated steel belt. The at least one tension member 3 may be uncoated. Alternatively, the at least one tension member 3 may be coated with a coating, e.g. with a coating having the form of a polymer jacket. In a particular embodiment, the at least one tension member 3 may be a belt comprising a plurality of polymer coated steel cords (not shown). The elevator system 2 may have a traction drive including a traction sheave for driving the at least one tension member 3.

In the exemplary embodiment depicted in FIG. 1, a 1:1 roping is employed for suspending the elevator car 6. The type of the roping is, however, not essential for the invention and different kinds of roping, e.g. a 2:1 roping or a 4:1 roping may be employed as well.

A landing door 10 is provided at each of the landings 8. The elevator car 6 is provided with a corresponding elevator car door 11 for allowing passengers to transfer between a landing 8 and the interior of the elevator car 6, when the elevator car 6 is positioned at the respective landing 8.

For moving the elevator car 6 along the hoistway 4 between the different landings 8, the elevator drive system 5 may be controlled by an elevator controller 15 of the elevator system 2.

The elevator system 2 may be a machine room-less elevator system 2. In an alternative embodiment, the elevator system 2 may comprise a machine room 13 housing the elevator drive system 5 and the elevator controller 15.

Input to the elevator controller 15 may be provided via landing control panels 7a provided on every landing 8, in particular in the vicinity of the landing doors 10, and/or via an elevator car control panel 7b provided inside the elevator car 6.

The landing control panels 7a may comprise elevator hall call buttons and/or destination call buttons. Destination call buttons allow passengers to enter their respective destinations before entering the elevator car 6. In case the landing control panels 7a are equipped with destination call buttons, no elevator car control panel 7b needs to be provided inside the elevator car 6 since the elevator system 2 is fully controlled by the commands input via the landing control panels 7a.

The landing control panels 7a and the elevator car control panel 7b may be coupled with the elevator controller 15 by means of electrical wiring not shown in FIG. 1, in particular by an electric bus, or by wireless data connections.

The elevator car 6 is provided with a movable balustrade 20 projecting vertically from the top of the elevator car 6 along the longitudinal direction LD for preventing persons 50, in particular mechanics, standing on the roof 6a of the elevator car 6 from accidentally falling off the elevator car 6.

In the exemplary embodiment depicted in FIG. 1, only a single movable balustrade 20 is provided at one side of the elevator car 6. In further embodiments, which are not explicitly depicted in the figures, the elevator car 6 may be equipped with multiple movable balustrades 20. The elevator car 6 may in particular comprise at least one movable balustrade 20 at each side of the elevator car 6.

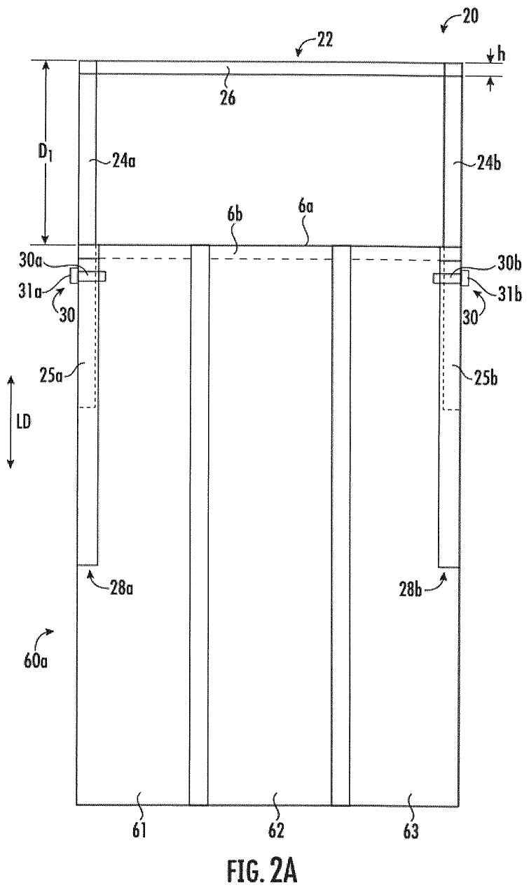

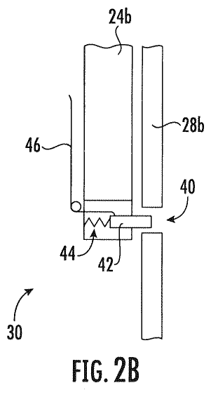

FIG. 2A depicts a schematic side view of a sidewall 60a of an elevator car 6 according to an exemplary embodiment of the invention that is equipped with a movable balustrade 20.

The sidewall 60a comprises three panels 61-63, in particular three outer panels 61-63, that are arranged next to each other for forming the sidewall 60a of the elevator car 6.

In further embodiments, which are not explicitly depicted in the figures, the sidewall 60a may comprise fewer or more than three panels 61-63.

A guide member 28a, 28b is provided on each lateral side of the sidewall 60, respectively. More particularly, a first guide member 28a is attached to and supported by a first panel 61 depicted on the left side of FIG. 2A, and a second guide member 28b is attached to and supported by a third panel 63 depicted on the right side of FIG. 2A.

Each of the first and second guide members 28a, 28b extends along the longitudinal direction LD and comprises a hollow channel that also extends along the longitudinal direction LD.

FIG. 2A further depicts a movable balustrade 20 that is movably attached to the sidewall 60a of the elevator car 6.

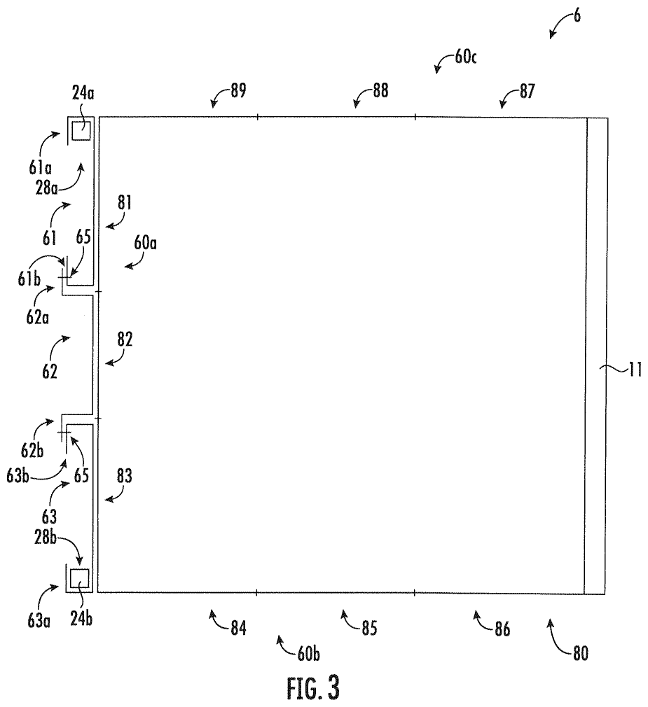

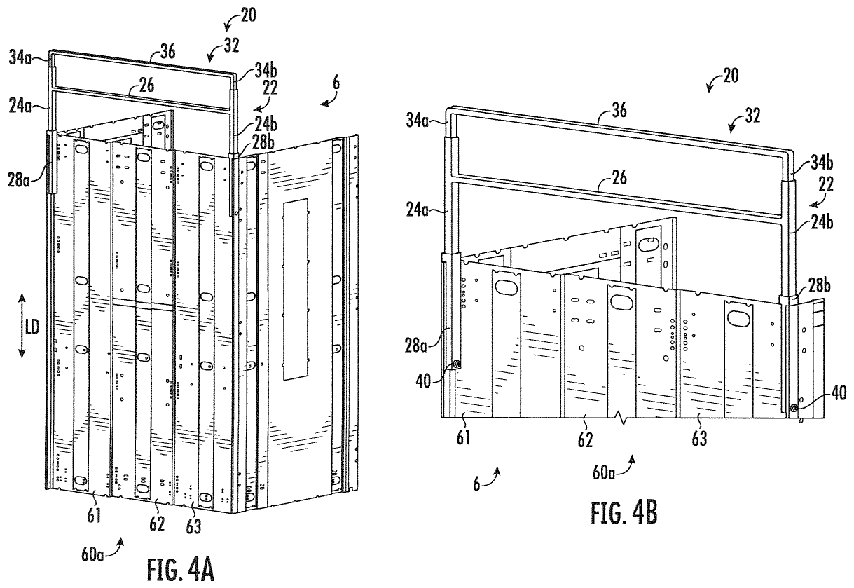

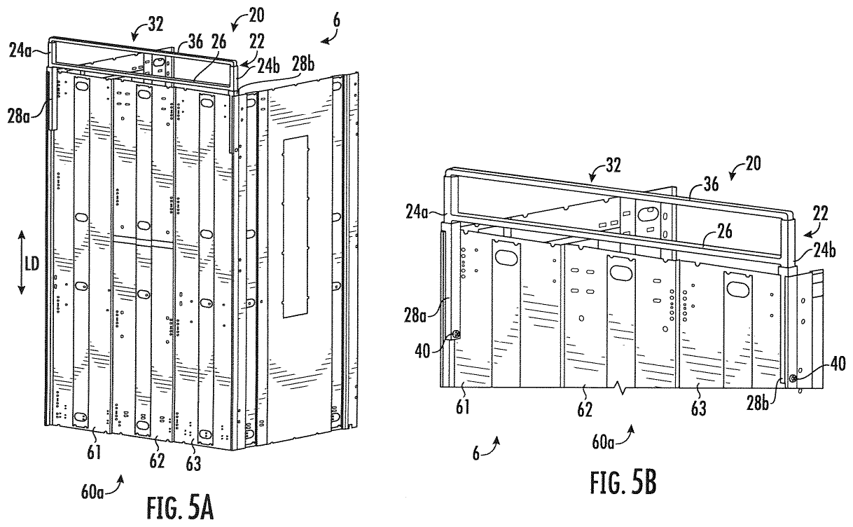

The movable balustrade 20 comprises a movable element 22. Further embodiments of the movable balustrade 20 may comprise more than one movable element 22. An exemplary embodiment of a movable balustrade comprising two movable elements 22, 32 is described further below with reference to FIGS. 4A to 5B.

The movable element 22 depicted in FIG. 2A includes a first leg 24a and a second leg 24b extending along the longitudinal direction LD, and a connecting element 26 that extends perpendicularly to the longitudinal direction LD between first and second legs 24a, 24b.

A lower portion 25a of the first leg 24a extends into the hollow channel formed in the first guide member 28a. A lower portion 25b of the second leg 24b extends into the hollow channel formed in the second guide member 28b.

The dimensions of the first and second legs 24a, 24 and of the hollow channels formed in the first and second guide members 28a, 28b are set so that the first and second legs 24a, 24 are movable in the hollow channels along the longitudinal direction LD. As a result, the movable element 22 of the movable balustrade 20 is linearly movable along the longitudinal direction LD between an extended position as depicted in FIG. 2A in which the at least one movable element 22 projects a first distance D1 from the roof 6a of the elevator car 6, and a retracted position (not shown) in which the at least one movable element 22 projects a second distance D2 from the roof 6a of the elevator car 6 that is smaller than the first distance D1.

When arranged in the extended position, the movable element 22 may, for example, project a first distance D1 of 700 mm to 900 mm from the roof 6a of the elevator car 6.

When arranged in the retracted position, the lower side of the connecting element 26 of the movable element 22 may abut against the roof 6a of the elevator car 6 so that the movable element 22 projects from the roof 6a of the elevator car 6 only over a second distance D2 that corresponds to the height h of the connecting element 26 in the longitudinal direction LD.

A recess or groove 6b may be formed at the top of the elevator car 6, in particular in the roof 6a of the elevator car 6, for accommodating the connecting element 26 when the movable element 22 is arranged in the retracted position, so that the movable element 22, when arranged in the retracted position, does not project from the roof 6a of the elevator car 6.

The elevator car 6 may further comprise a locking mechanism 30 that allows for locking the movable element 22 in the retracted position and/or in the extended position, respectively.

The exemplary embodiment of the locking mechanism 30 depicted in FIG. 2A comprises first bolt or screw 30a extending perpendicularly to the longitudinal direction LD through corresponding openings (not shown) formed in the first leg 24a and in the first guide member 28a and a second bolt or screw 30b extending perpendicularly to the longitudinal direction LD through corresponding openings (not shown) formed in the second leg 24b and in the second guide member 28b, respectively.

When extending though the openings, as it is depicted in FIG. 2A, the bolts or screws 30a, 30b prevent the legs 24a, 24b from moving along the longitudinal direction LD with respect to the guide members 28a, 28b.

In order to allow for moving the movable element 22 between the retracted position and the extended position, the bolts or screws 30a, 30b may be moved out of the corresponding openings.

Screws 30a, 30b extending through the openings may be secured by nuts 31a, 31b, for example by butterfly nuts 31a, 31b, that are screwed onto the screws 30a, 30b.

Alternatively, the openings formed in the first and second legs 24a, 24b and/or in the first and second guide members 28a, 28b may be provided with threads in order to allow for fixing the screws 30a, 30b in the openings by screwing the screws 30a, 30b into the openings.

FIG. 2B depicts a schematic sectional view of a locking mechanism 30 that may be implemented in an elevator car 6 according to an exemplary embodiment of the invention.

The locking mechanism 30 depicted in FIG. 2B comprises a movable latch 42 that is provided in at least one of the legs 24a, 24b for engaging with a notch, recess or opening 40 that is formed in at least one of the guide members 28a, 28b for locking the locking mechanism 30. The locking mechanism 30 may in particular comprise at least one elastic element 44 that is configured for urging the at least latch 42 into a locking position in which it extends into the notch, recess or opening 40.

The latch 42 may be movable out of engagement with the notch, recess or opening 40 for unlocking the locking mechanism 30. The locking mechanism 30 may in particular comprise a traction member 46, such as a rope or cable, that allows for selectively disengaging the latch 42 from the notch, recess or opening 40 by pulling the traction member 46.

A locking mechanism 30 comprising such a traction member 46 allows for very conveniently unlocking the locking mechanism 30 from the roof 6a of the elevator car 6.

In an alternative embodiment, the locking mechanism 30 may be provided without a traction member 46. In this embodiment, the latch 42 can be pushed manually out of engagement with the notch, recess, or opening 40 to unlock the locking

### Mechanism 30.

FIG. 3 depicts a schematic sectional view of an elevator car 6 comprising a movable balustrade 20 according to an exemplary embodiment of the invention. In the illustration depiction in FIG. 3, the section plane is oriented perpendicularly to the longitudinal direction LD.

The elevator car 6 depicted in FIG. 3 comprises a structural frame 80 comprising a plurality of structural panels 81-89 forming the sidewalls 60a-60c of the elevator car 6.

Outer panels 61-63, for example laminated panels, may be attached to the outsides of the structural panels 81-89.

In the exemplary embodiment depicted in FIG. 3, outer panels 61-63 are attached to the outsides of the structural panels 81-83 opposite to the elevator car door 11.

Although not explicitly depicted in FIG. 3, additional outer panels may be attached to the outsides of the structural panels 84-89 forming the lateral sidewalls 60b, 60c of the elevator car 6, too.

The number of the outer panels 61-63 may correspond to the number of structural panels 81-89 forming the respective sidewall 60a-60c, as depicted in FIG. 3. In alternative embodiments, which are not explicitly depicted in the figures, the number of the outer panels 61-63 may differ from the number of structural panels 81-89 of the respective sidewall 60a-60c.

In the embodiment depicted in FIG. 3, the outermost outer panels 61, 63 comprise U-shaped end portions 61a, 61b, 63a, 63b with the outermost U-shaped end portions 61a, 63a forming hollow guide members 28a, 28b configured for accommodating and guiding the lower end portions 25a, 25b of the legs 24a, 24b of the movable element 22, as it has been described before with reference to FIG. 2A.

The central outer panel 62 is provided as a U-shaped profile comprising two wings 62a, 62b that extend laterally form the outer ends of the legs of the U-shaped profile. The wings 62a, 62b of the central outer panel 62 overlap with the inner U-shaped end portions 61b, 63b of the outermost outer panels 61, 63. This overlap allows for fixing the outermost outer panels 61, 63 to the central outer panel 62 by an adhesive and/or by fixing elements 65 such as bolts or screws 65 extending through the overlapping portions of adjacent outer panels 61-63.

FIGS. 4A to 5B depict perspective views of portions of an elevator car 6 comprising a movable balustrade 20 according to a further embodiment of the invention.

FIG. 4A depicts a perspective view of the movable balustrade 20 in an extended configuration. FIG. 4B depicts an enlarged view of the movable balustrade 20 depicted in FIG. 4A.

FIG. 5A depicts a perspective view of the movable balustrade 20 in a retracted configuration. FIG. 5B depicts an enlarged view of the movable balustrade 20 depicted in FIG. 5A.

Similar to the embodiment depicted in FIGS. 2A and 3, the embodiment depicted in FIGS. 4A to 5B comprises two guide members 28a, 28b that are attached to and supported by the outer panels 61, 63 of a sidewall 60a of the elevator car 6.

In the embodiment depicted in FIGS. 4A to 5B, the movable balustrade 20 comprises two movable elements 22, 32 that are movable with respect to each other and with respect to the elevator car 6 along the longitudinal direction LD.

The movable balustrade 20 includes a first movable element 22 that comprises first and second legs 24a, 24b extending parallel to each other along the longitudinal direction LD, and a connecting element 26 that extends perpendicularly to the longitudinal direction LD between first and second legs 24a, 24b of the first movable element 22.

The movable balustrade 20 further includes a second movable element 32 that comprises first and second legs 34a, 34b extending parallel to each other along the longitudinal direction LD and a connecting element 36 that extends perpendicularly to the longitudinal direction LD between first and second legs 34a, 34b of the second movable element 32.

Similar to the embodiment depicted in FIGS. 2 and 3, the first and second legs 24a, 24b of the first movable element 22 are movably accommodated in hollow channels formed in the guide members 28a, 28b.

In the embodiment depicted in FIGS. 4A to 5B the first and second legs 24a, 24b of the first movable element 22 are formed with hollow channels as well. The first and second legs 34a, 34b of the second movable element 32 are movably accommodated in the hollow channels that are formed in the first and second legs 24a, 24b of the first movable element 22.

As a result, the first and second movable elements 22, 32 of the movable balustrade 20 depicted in FIGS. 4A to 5B form a telescopic mechanism that allows for moving the first and second movable elements 22, 32 along the longitudinal direction LD between an extended position as it is depicted in FIGS. 4A and 4B and a retracted position as it is depicted in FIGS. 5A and 5B.

In further embodiments, which are not explicitly depicted in the figures, the movable balustrade 20 may comprise more than two movable elements 22, 32, for example three, four or five movable elements 22, 32, that are telescopically movable with respect to each other.

A movable balustrade 20 comprising two or more movable elements 22, 32 allows for reducing the distance each of the movable elements 22, 32 is moved between the extended position and the retracted position. It further allows for reducing the space that is occupied by the movable balustrade 20 in the retracted configuration without reducing the height of the movable balustrade 20 in the extended configuration.

Although it is not explicitly depicted in FIGS. 4A to 5B, the movable balustrade 20 depicted in said figures may be equipped with at least one locking mechanism 30 that is similar to one of the locking mechanisms that have been described above.

While the invention has been described with reference to exemplary embodiments, it will be understood by those skilled in the art that various changes may be made and equivalents may be substituted for elements thereof without departing from the scope of the invention. In addition, many modifications may be made to adopt a particular situation or material to the teachings of the invention without departing from the essential scope thereof. Therefore, the invention is not intended to be limited to the specific embodiments disclosed, but to encompass all embodiments within the scope of the appended claims.

What is claimed is:

1. Elevator car (6) comprising
at least one movable balustrade (22) configured to transition between a retracted configuration and an extended configuration in which the at least one movable balustrade (22) projects from a top of the elevator car (6), the at least one movable balustrade (22) comprising at least one movable element (22, 32) that is linearly movable between a retracted position and an extended position.

2. Elevator car (6) according to claim 1,
wherein the at least one movable element (22, 32) projects a first distance (D1) from the top of the elevator car (6) when it is arranged in the extended position; and
wherein the at least one movable element (22) projects a second distance (D2) that is smaller than the first distance (D1) from the top of the elevator car (6) when it is arranged in the retracted position; or
wherein the at least one movable element (22) does not project from the top of the elevator car (6) when it is arranged in the retracted position.

3. Elevator car (6) according to claim 1, wherein the at least one movable balustrade (22) comprises:
a first movable element (22) that is linearly movable with respect to a sidewall (60a) of the elevator car (6); and
a second movable element (32) that is linearly movable with respect to the first movable element (22).

4. Elevator car (6) according to claim 3, wherein each of the first and second movable elements (22, 32) comprises at least one leg (24a, 24b, 34a, 34b) extending along a longitudinal direction (LD).

5. Elevator car (6) according to claim 4, wherein each of the first and second movable elements (22, 32) comprises at least two legs (24a, 24b, 34a, 34b) extending parallel to each other along the longitudinal direction (LD) and a connecting element (26, 36) extending between the at least two legs (24a, 24b, 34a, 34b).

6. Elevator car (6) according to claim 4, wherein at least a lower portion of the at least on leg (34a, 34b) of the second movable element (32) is movably arranged in a corresponding leg (24a, 24b) of the first movable element (22).

7. Elevator car (6) according to claim 4 further comprising at least one guide member (28a, 28b) that is attached to a sidewall (60a) of the elevator car (6), wherein at least a lower portion (25a, 25b) of the at least one leg (24a, 24b) of the first movable element (22) is movably arranged in the at least one guide member (28a, 28b).

8. Elevator car (6) according to claim 7, wherein a sidewall (60a) of the elevator car (6) comprises at least one structural panel (81, 82, 83) and at least one outer panel (61, 62, 63) that is attached to an outside of the at least one structural panel (81, 82, 83) and wherein the at least one guide member (28a, 28b) is attached to, or formed by, the at least one outer panel (61, 62, 63);
wherein the at least one outer panel (61, 62, 63) comprises in particular at least one U-shaped portion (61a, 61b, 63a, 63b) and wherein the at least one guide member (28a, 28b) is in particular attached to, or formed by, the at least one U shaped portion (61a, 61b, 63a, 63b) of the at least one outer panel (61, 62, 63).

9. Elevator car (6) according to claim 3 further comprising at least one third movable element that is linearly movable with respect to the first and second movable elements (22, 32).

10. Elevator car (6) according to claim 1 further comprising at least one locking mechanism (30) that allows for locking the at least one movable element (22, 32) in at least one of the retracted position and the extended position.

11. Elevator car (6) according to claim 10,
wherein the at least one locking mechanism (30) comprises at least one screw or bolt (30a, 30b) extending transversely through the at least one movable element (22, 32).

12. Elevator car (6) according to claim 10,
wherein the at least one locking mechanism (30) comprises at least one latch (54) that engages with a corresponding notch, recess or opening (40) for locking the locking mechanism (30), wherein the at least one latch (42) is movable out of engagement with the corresponding notch, recess or opening (40) for unlocking the locking mechanism (30); wherein the at least one locking mechanism (30) comprises in particular a traction member (46), such as a rope or cable, that allows for selectively disengaging the at least one latch from the traction member (46) by pulling the traction member (46).

13. Elevator car (6) according to claim 11, wherein the locking mechanism (30) comprises at least one elastic element (44) that is configured for urging the at least one bolt (30a, 30b) or latch (42) into a locking position in which it locks the at least one movable element (22, 32).

14. Elevator system (2) comprising:
an elevator car (6) according to claim 1 that is configured for traveling in a hoistway (4) along a longitudinal direction (LD) between a plurality of landings (8).

15. Method of transitioning the configuration of at least one movable balustrade (22) provided at an elevator car (6) between a retracted configuration and an extended configuration;
wherein the method includes moving at least one movable element (22, 32) of the at least one movable balustrade (22) linearly between a retracted position and an extended position in which the at least one movable element (22, 32) projects from the top of the elevator car (6);
wherein the method in particular includes unlocking the at least one movable element (22, 32) before moving the at least one movable element (22, 32) and locking the at least one movable element (22, 32) after moving the at least one movable element.
